(19) United States
(12) Patent Application Publication
(10) Pub. No.: US 2025/0164792 A1
(43) Pub. Date: May 22, 2025

(54) Processing Means and Display System

(71) Applicant: Envisics Ltd, Milton Keynes (GB)

(72) Inventor: Timothy Smeeton, Milton Keynes (GB)

(21) Appl. No.: 18/841,331

(22) PCT Filed: Mar. 7, 2023
(86) PCT No.: PCT/EP2023/055715

§ 371 Date: Aug. 23, 2024

(30) Foreign Application Priority Data
Mar. 9, 2022 (GB) 2203267.6

(51) Int. Cl. G02B 27/01

(52) U.S. Cl. CPC G02B 27/0172; G02B 2027/0178

(57) ABSTRACT

A processing means is disclosed. The processing means is for use in a display system to display a picture in an eye box to a user. The processing means is configured to: receive a signal indicative of a presence a polarizing element in the eye box; determine a corrective data set for the picture based on the signal; and output the corrective data set to the display system such that the picture is displayed based on the presence of the polarizing element.

### FIELD

The present disclosure relates to a processing means for use in a display system, in particular, for a display system using diffracted light field comprising diverging ray bundles. More specifically, the present disclosure relates a processing means for a display system comprising a waveguide pupil expander and to a method of pupil expansion using a waveguide. Some embodiments relate to a picture generating unit and a head-up display, for example an automotive head-up display (HUD).

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other embodiments, the image is a real image formed by holographic reconstruction and the image is projected or relayed to the viewing plane. The image is formed by illuminating a diffractive pattern (e.g., hologram) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some examples, an image (formed from the displayed hologram) is propagated to the eyes. For example, spatially modulated light of an intermediate holographic reconstruction/image formed either in free space or on a screen or other light receiving surface between the display device and the viewer, may be propagated to the viewer.

In some other examples, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 meter viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer.

In other words, not all parts of the image are visible from any one point on the viewing plane (e.g., any one eye position within a viewing window such as eye-motion box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 meter. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels). Embodiments of the present disclosure relate to a configuration in which a hologram of an image is propagated to the human eye rather than the image itself. In other words, the light received by the viewer is modulated according to a hologram of the image. However, other embodiments of the present disclosure may relate to configurations in which the image is propagated to the human eye rather than the hologram—for example, by so called indirect view, in which light of a holographic reconstruction or “replay image” formed on a screen (or even in free space) is propagated to the human eye.

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure relates to non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window—e.g., eye-box or eye motion box for viewing by the viewer. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The hologram may be represented, such as displayed, on a display device such as a spatial light modulator. When displayed on an appropriate display device, the hologram may spatially modulate light transformable by a viewing system into the image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram is described herein as routing light into a plurality of hologram channels merely to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be arbitrarily divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels. However, in some arrangements, a plurality of spatially separated hologram channels is formed by intentionally leaving areas of the target image, from which the hologram is calculated, blank or empty (i.e., no image content is present).

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

Broadly, a processing means is disclosed herein that corrects a picture received by a user at an eye-box when a polarizing element or filter obscures the eye of the user. The processing means receives a signal indicative of the presence of a polarizing element or filter at the eye box. The processing means determines a corrective data set of the picture to be displayed to the user based on the signal. The processing means outputs the corrective data set to the display system to display the picture to a user.

The use of such a processing means allows for a correction to the picture to be made based on the presence (or absence) of a polarizing element or filter. A polarizing element or filter may cause a change (e.g. reduction) in image quality that the user perceives because the intensity of the light reaching the eye-box is a complex function of angle of incidence on the windscreen and direction of polarization of the light received by a combiner on an optical path to the eye-box (i.e. the light received from the picture generating unit). In some embodiments, the light received at the eye-box has a p-polarization component and an s-polarization component. In embodiments, the s-polarization component is dominant owing to the geometry of the system. That is, the intensity of the s-polarization component reaching the eye-box is greater than that of the p-polarization component. This may be true regardless of the direction of polarization of the light emitted by the picture generating unit. For convenience, it is sometimes said that there is a dominant polarization state. The present disclosure relates to a combiner that is curved and angled. In some embodiments, the combiner is a vehicle windscreen that is tilted relative to the forwards direction and is curved. That is, the windscreen is not straight across in front of the driver.

The combiner may have a so-called “rake angle” and the projection system has a field of view. The angle of incidence for picture light received by the combiner is a function of position within the field of view. For example, the angle of incidence for picture light which appears at the bottom of the field of view may be e.g. 65 degrees and the angle of incidence for picture light which appears at the top of the field of view may be e.g. 55 degrees. Owing to range of angles of incidence associated with the field of view and the dependence of polarization on reflectivity, the intensity profile of the field of view is distorted.

Image compensation may be performed. In examples that involve the propagation of hologram to the eye-box, the inventors have found that correction should be performed on the target image prior to, or as part of, the hologram calculation. Image compensation may be based on an eye-box location. This is because the picture light received at different locations within the eye-box has been subject to different numbers of internal reflections within the waveguide pupil expander. Since the internal reflections within the pupil expander are inherently lossy this results in variations in intensity of light at different eye-box positions. In addition, this variation may be dependent upon the wavelength of light as discussed below. Typically, image compensation is based on the preferential or dominate polarization state that it directed towards the eye-box by the combiner. If a polarizing element is incorporated at the eye-box (e.g. by the viewer), image compensation based on prior art techniques may be ineffective or counter-productive.

In some embodiments, the corrective data set is a first set of values if the signal indicates the presence of the polarizing element or filter, and a second set of values in the absence of an indication of the polarizing element or filter in the eye box. The second set of values and first set of values being different. The first set of values may apply a correction to each of the pixels to be displayed, and the second set of values may apply no correction, such that a factor of 1 is applied to all pixels. Thus, each value of the corrective data set may comprise a scaling factor for a respective image pixel to correct or compensate for the properties of components of the projection or relay system of the display system (e.g. optical combiner and pupil expander) and, in the case of the first set of values, the presence of a polarizing element or filter at the eye-box. The skilled person will appreciate that the corrective data set may be applied to any target image prior to hologram calculation and display thereof by the display system.

In some embodiments, the signal indicates the presence of the polarizing element or filter, the corrective data set modifies an intensity profile of the picture, such that the picture observed by the user has an intended intensity profile after filtering by the polarizing element or filter. The intended intensity profile may be substantially uniform.

In some embodiments, the corrective data set comprises at least one of a luminance correction function or profile and a colour balance correction function or profile.

Broadly, an augmented reality display system is disclosed. The augmented reality display system comprises a display device, a combiner and processing means. The display device is configurable to receive visible light from a visible light source and modify the light such that picture bearing light is relayed from the display device to a user at an eye box. The combiner is configurable to receive the picture bearing light from the display device and combine it with an external scene to present an augmented reality scene to the user. The processing means receives a signal indicative of the presence of a polarizing filter in the eye box. The processing means determines a corrective data set of the picture to be displayed to the user based on the signal. The corrective data set may be dependent upon the eye-box position of the user. The processing means outputs the corrective data set to the display system to display the picture to a user.

The combiner may have a different reflectivity for different polarization states. The processing means may be configured to modify the corrective data set (or select a different corrective data set) based on the reflectivity of the different polarization states, and the presence of the polarizing filter to improve the quality of the image seen by the user.

Broadly, a user-tracking system, such as an eye tracking system is disclosed. The eye tracking system comprises a sensor to image at least one eye of a user, the eye located at an eye box of a display system. The eye tracking system further comprises a light source to illuminate the eye of the user. The light source is operated in a first mode and a second mode, the first mode using light of a first polarization state and the second mode using light of a second polarization state. The display system, such as the processing means thereof, receives a signal indicative of the presence of a polarizing filter in the eye box. The processing means determines a corrective data set of the picture to be displayed to the user based on the signal. The corrective data set may be further determined based on the position of the user's eye within the eye box sensed by the eye tracking system. The processing means outputs the corrective data set to the display system to display the picture to a user.

The first polarization state may comprise a polarized state of light (e.g. a linearly polarized state of light), and the second polarized state may comprise substantially unpolarized light. The first polarization state may enable a system to detect whether a polarizing filter is present in the eye box. The second polarization state is used to detect the eye/s regardless of whether or not the polarizing filter is present.

The duration of the first state may be less than the second state. The duration of the first state may be less than 10% of the duration of the overall cycle. The duration of the first state may be less than 5% of the duration of the overall cycle. The duration of the first state may be less than 1% of the duration of the overall cycle. This increases the amount of time the system is able to track the eye.

The first polarization state may be horizontally polarized such that it is blocked by typical polarized sunglasses (which are typically vertically polarized). The second polarization state may be substantially vertically polarized light. The first and second polarization states may be opposite or perpendicular polarization states (e.g. linear polarisation states).

The eye tracking system may be used in a vehicle.

The augmented reality system may be used as a part of a head up display.

Broadly, the present disclosure relates to a method of modifying, correcting or improving a picture from the perspective of a viewer. The method comprises: receiving an indication of a presence of a polarizing filter; determining, based on the indication of the presence of the polarizing filter, a corrective data set of/for a picture to be displayed to a user of a display system; and outputting the corrective data set to the display system to display the picture in the eye box using the corrective data set.

The core projection system disclosed herein utilizes user-tracking, such as eye-tracking, in order to improve the augmented reality experience. Notably, there is disclosed herein a system that puts the user-tracking system to an additional and complementary use. In some embodiments, the user-tracking system is operated in an additional, different operating mode. For example, a first operating mode may comprise conventional user-tracking and the second operating mode, in accordance with the present disclosure, may comprise detecting whether the user is wearing polarizing glasses. The second operating mode comprises operating the user-tracking system differently to the first operating mode. The user-tracking system illuminates a user area (e.g. viewing window or eye-box) with light such as non-visible light e.g. infrared light. In some embodiments, the second operating mode of the user-tracking system comprises changing a property of the light that illuminates the user area, or using a different light source that emits light having a different property to that used in the first operating mode. The property may be polarization. In the first operating mode, the user-tracking system may illuminate the user area with non-visible light having a first polarization state (e.g. a first direction of linear polarization) and, in the second operating mode, the user-tracking system may illuminate the user area with non-visible light having a second polarization state (e.g. second direction of linear polarization). In accordance with the present disclosure, images of the user area captured by the user-tracking system are analysed, in the second operating mode, to determine or deduce a polarization state of light received by the viewer.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffractive or diffracted light may be output by a display device such as a pixelated display device such as a spatial light modulator (SLM) arranged to display a diffractive structure such as a hologram. The diffracted light field may be defined by a “light cone”. Thus, the size of the diffracted light field (as defined on a two-dimensional plane) increases with propagation distance from the corresponding diffractive structure (i.e. display device).

The spatial light modulator may be arranged to display a hologram. The diffracted or diverging light may comprise light encoded with/by the hologram, as opposed to being light of an image or of a holographic reconstruction. In such embodiments, it can therefore be said that the pupil expander replicates the hologram or forms at least one replica of the hologram, to convey that the light delivered to the viewer is spatially modulated in accordance with a hologram of an image, not the image itself. That is, a diffracted light field is propagated to the viewer.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

Reference is made herein to different “corrective data sets” that are used to modify a picture (e.g. image data representing an array of pixels of the picture) before hologram calculation and/or projection. Each corrective data set comprises an array of numbers, wherein there is a number for each pixel of a picture that can be modified using the corrective data set. The corrective data set may be an array of pixel correction values. The array of pixel correction values may be the same size as the array of pixels of the picture. There may therefore be a 1:1 correlation between pixels of the corrective data set and pixels of the picture. Each pixel correction value may correspond to a pixel of the picture. However, the person skilled in the art of image processing will understand that the corrective data set may take other forms. The corrective data set may compensate for variations introduced by an optical component of a projection system between the display device to the eye-box of the optical system, such as an optical combiner or pupil expander. For instance, each pixel value of the corrective data set may be calculated based on local property of an optical combiner (e.g. vehicle windscreen) used as part of a projection system. In some embodiments described herein, the reflectivity of an optical component of the projection system (e.g. the optical combiner such as vehicle windscreen) is effectively non-uniform owing to different parts of the picture having a different angle of incidence on the optical component. For example, the corrective data set may be configured to correct for non-uniform reflectivity. In some embodiments described herein, the reflectivity of an optical component of the projection system (e.g. the pupil expander) is wavelength dependent leading to non-uniform colour balance of polychromatic pictures (e.g. comprising red, green and blue monochromatic pictures). The corrective data set may be configured to correct for non-uniform colour balance. The skilled person will be aware that a variety of different measurement techniques or mathematical calculations using e.g. Fresnel's equations may be used to determine the reflectivity at a plurality of different points on the optical component. The present disclosure is not limited to any particular method of determining the corrective data sets.

In some embodiments, a first corrective data set is used (i.e. apply to the picture before further processing and/or projection) in first operating mode and a second (i.e. different) corrective data set is used in a second operating mode. In some embodiments, a first corrective data set is used in the first operating mode and, in the second operating mode, a corrective data set in accordance with this disclosure is not used. In some embodiments, the operating mode is related to polarisation such as a polarisation of the light of the picture. In some embodiments, the first operating mode is used in relation to light of a first direction of linear polarisation (e.g. p-polarised) and the second operating mode is used in relation to light of a second direction of linear polarisation (e.g. s-polarised), wherein the first direction and second direction are perpendicular. In some embodiments, the operating mode is selectable by a user. In other embodiments, the operating mode is detected by the system. The skilled person will be familiar with the idea that the corrective data set may be mathematically “applied to” or “used on” the picture by e.g. multiplication such as multiplying each pixel value of the picture by a corresponding or respective pixel value of the corrective data set. The picture may be modified using the selected corrective data set prior to other image processing steps and/or prior to calculation of a hologram of the picture for a holographic projection system.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

In the present disclosure, the term “substantially” when applied to a structural units of an apparatus may be interpreted as the technical feature of the structural units being produced within the technical tolerance of the method used to manufacture it.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8;

FIG. 3 shows a hologram displayed on an LCOS that directs light into a plurality of discrete areas.

FIG. 4 shows a system, including a display device that displays a hologram that has been calculated as illustrated in FIGS. 2 and 3;

FIG. 5 shows a perspective view of a system comprising two replicators arranged for expanding a light beam in two dimensions;

FIG. 6A illustrates a configuration, in accordance with embodiments, in which the windscreen is tilted with respect to the forward direction of the viewer;

FIGS. 6B and 6C illustrate the intensity of horizontally and vertically polarized light received by the viewer;

FIGS. 7A and 7B illustrate a perceived luminosity profile for a display viewed with and without the presence of polarizing filters.

FIGS. 8A and 8B illustrate a desired perceived luminosity profile for a display, and a corrected profile viewed in the presence of a polarizing filter.

FIGS. 9A and 9B illustrate the detection of a user's eyes and the absence of the detection of a user's eyes.

FIG. 10 illustrates a processing means in accordance with some embodiments.

FIG. 11 illustrates an augmented reality display system in accordance with some embodiments.

FIG. 12 illustrates an eye tracking system in accordance with some embodiments.

FIG. 13 illustrates a method in accordance with some embodiments.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

### Optical Configuration

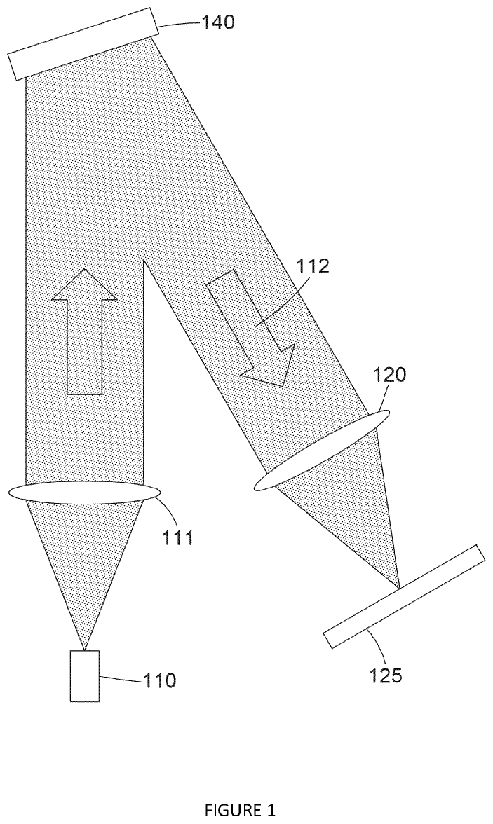

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods. British patent application GB 2112213.0 filed 26 Aug. 2021, incorporated herein by reference, discloses example hologram calculation methods that may be combined with the present disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Light Modulation

The display system comprises a display device defining the exit pupil of the display system. The display device is a spatial light modulator. The spatial light modulation may be a phase modulator. The display device may be a liquid crystal on silicon, “LCOS”, spatial light modulator.

### Light Channeling

The optical system disclosed herein is applicable to pupil expansion with any diffracted light field. In some embodiments, the diffracted light field is a holographic light field—that is, a complex light field that has been spatially modulated in accordance with a hologram of an image, not the image itself. In some embodiments, the hologram is a special type of hologram that angularly divides/channels the image content. This type of hologram is described further herein merely as an example of a diffracted light field that is compatible with the present disclosure. Other types of hologram may be used in conjunction with the display systems and light engines disclosed herein.

A display system and method are described herebelow, which comprise a waveguide pupil expander. As will be familiar to the skilled reader, the waveguide may be configured as a ‘pupil expander’ because it can be used to increase the area over (or, within) which the light emitted by a relatively small light emitter—such as a relatively small SLM or other pixelated display device as used in the arrangements described herein—can be viewed by a human viewer or other viewing system that is located at a distance, such as a relatively large distance, away from the light emitter. The waveguide achieves this by increasing the number of transmission points from which the light is output, towards the viewer. As a result, the light may be seen from a plurality of different viewer locations and, for example, the viewer may be able to move their head, and therefore their line of sight, whilst still being able to see the light from the light emitter. Thus, it can be said that the viewer's ‘eye-box’ or ‘eye-motion box’ is enlarged, through use of a waveguide pupil expander. This has many useful applications, for example but not limited to head-up displays, for example but not limited to automotive head-up displays.

A display system as described herein may be configured to guide light, such as a diffracted light field, through a waveguide pupil expander in order to provide pupil expansion in at least one dimension, for example in two dimensions. The diffracted light field may comprise light output by a spatial light modulator (SLM), such as an LCOS SLM. For example, that diffracted light field may comprise light that is encoded by a hologram displayed by the SLM. For example, that diffracted light field may comprise light of a holographically reconstructed image, corresponding to a hologram displayed by the SL M. The hologram may comprise a computer-generated hologram (CGH) such as, but not limited to, a point-cloud hologram, a Fresnel hologram, or a Fourier hologram. The hologram may be referred to as being a ‘diffractive structure’ or a ‘modulation pattern’. The SLM or other display device may be arranged to display a diffractive pattern (or, modulation pattern) that comprises the hologram and one or more other elements such as a software lens or diffraction grating, in a manner that will be familiar to the skilled reader.

The hologram may be calculated to provide channeling of the diffracted light field. This is described in detail in each of GB2101666.2, GB2101667.0, and GB2112213.0, all of which are incorporated by reference herein. In general terms, the hologram may be calculated to correspond to an image that is to be holographically reconstructed. That image, to which the hologram corresponds, may be referred to as an ‘input image’ or a ‘target image’. The hologram may be calculated so that, when it is displayed on an SLM and suitably illuminated, it forms a light field (output by the SLM) that comprises a cone of spatially modulated light. In some embodiments the cone comprises a plurality of continuous light channels of spatially modulated light that correspond with respective continuous regions of the image. However, the present disclosure is not limited to a hologram of this type.

Although we refer to a ‘hologram’ or to a ‘computer-generated hologram (CGH)’ herein, it will be appreciated that an SLM may be configured to dynamically display a plurality of different holograms in succession or according to a sequence. The systems and methods described herein are applicable to the dynamic display of a plurality of different holograms.

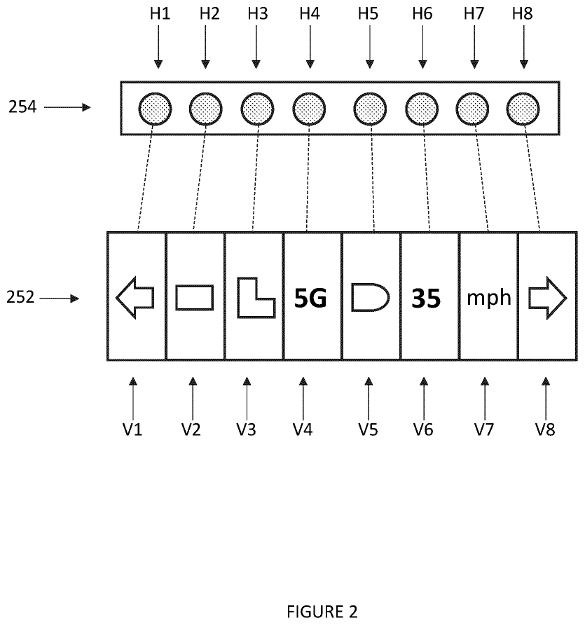

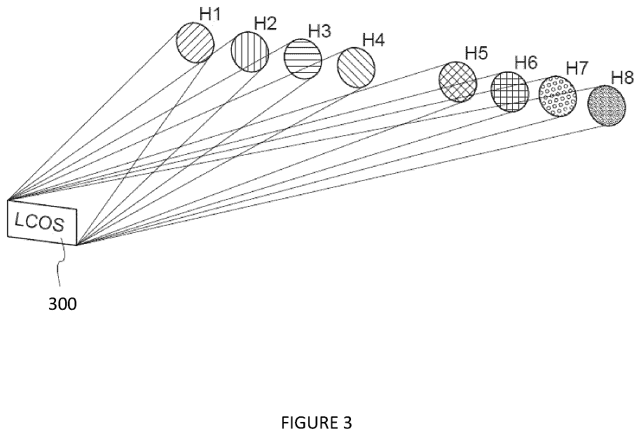

FIGS. 2 and 3 show an example of a type of hologram that may be displayed on a display device such as an SLM, which can be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channeling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of the entrance pupil of the viewing system.

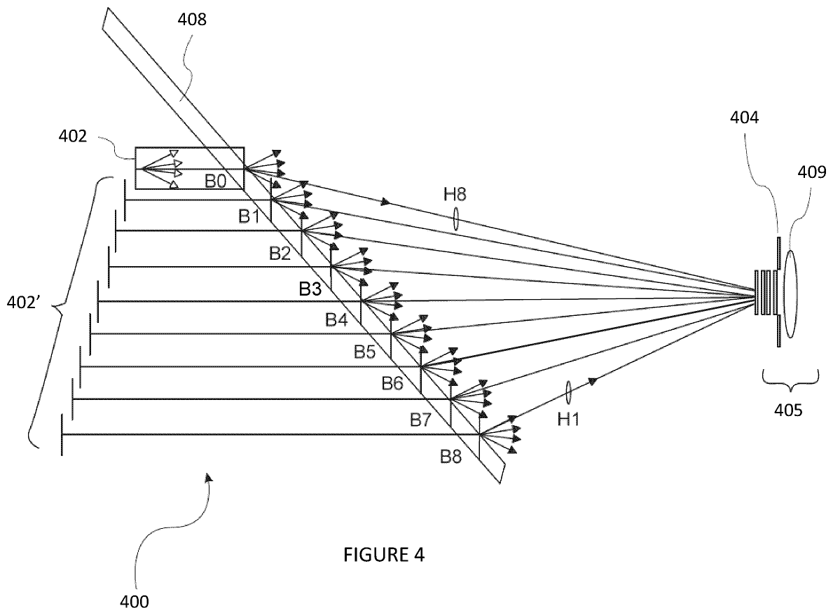

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The methods and arrangements described above can be implemented in a variety of different applications and viewing systems. For example, they may be implemented in a head-up-display (HUD) or in a head or helmet mounted device (HMD) such as an Augmented Reality (AR) HMD.

Although virtual images, which require the eye to transform received modulated light in order to form a perceived image, have generally been discussed herein, the methods and arrangements described herein can be applied to real images.

### Two-Dimensional Pupil Expansion

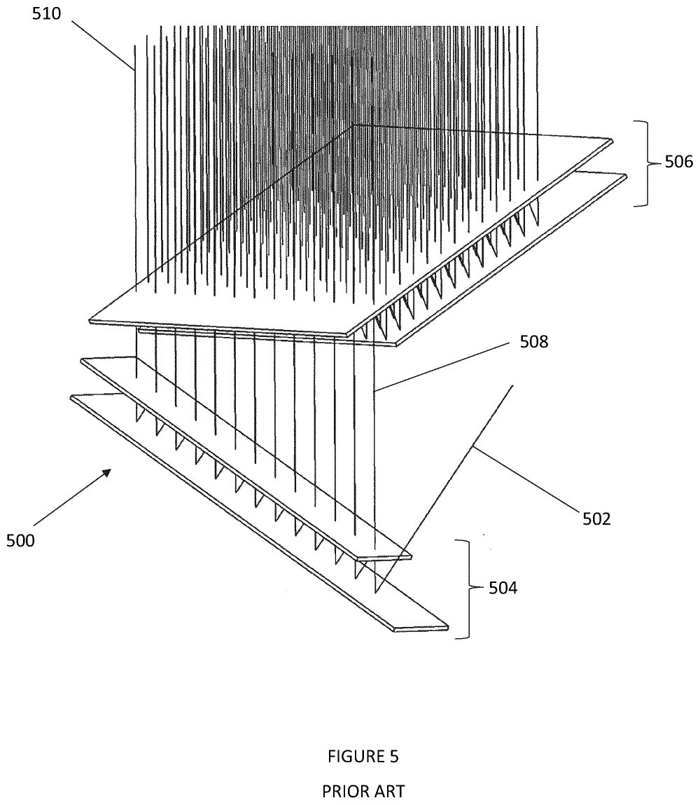

Whilst the arrangement shown in FIG. 5 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5 shows a perspective view of a system 500 comprising two replicators, 504, 506 arranged for expanding a light beam 502 in two dimensions.

In the system 500 of FIG. 5, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5 combine to provide a two-dimensional replicator (or, “two-dimensional pupil expander”).

Many types of augmented reality displays, such as head up displays, use at least one surface that has a different reflectivity between polarization states. For example, an angled combiner, such as a windshield of windscreen as typically used as the combiner in a vehicle, may have a different response to s-polarized and p-polarized light. As such the reflection of one type of light is typically favoured. This means that a display is typically optimized for substantially one type of polarized light.

To a first approximation, light with vertical linear polarization at the eye box (visible through polarized sunglasses) is predominately light which was incident on the windshield or combiner with p-polarization. Light with horizontal linear polarization at the eye box (not visible through polarized sunglasses) is predominately light which was incident on the windshield or combiner with s-polarization.

Existing driver monitoring systems (DMS) or eye tracking systems can detect whether a driver is wearing (sun)glasses or not. DMS typically use IR illuminators and an IR camera. The IR light propagates through sunglasses so the eye can be imaged in the IR camera and the eye location or gaze determined by software analysis of the camera image. The inventors have recognised that the output from the DMS may be used to improve the image quality perceived by the user.

A HUD is typically configured for good visibility both with and without polarized sunglasses. One way to achieve this is to have light emitted from the pupil replicator or waveguide with linear polarization such that after reflection by the combiner there are components both with vertical linear polarization (visible through polarized sunglasses, but with low reflection off the windshield because vertically polarized light is predominately p-polarized at the windshield) and horizontal linear polarization (not visible through polarized sunglasses, but with high reflection off the windshield because horizontally polarized light is predominately s-polarized at the windshield).

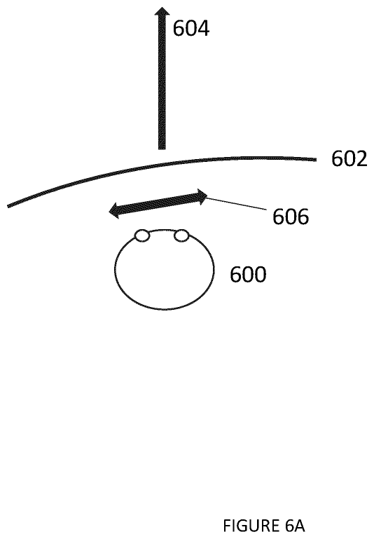

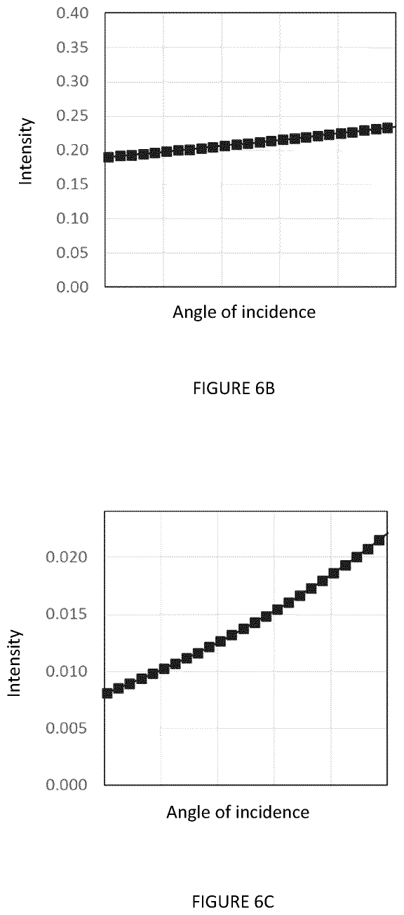

FIG. 6A shows a plan view of a head-up display system comprising a viewer 600 and vehicle windscreen 602 functioning as a combiner. The vehicle windscreen 602 is configured to receive picture light from a picture generating unit (not shown) under the dashboard of the vehicle (behind the page of FIG. 6A). A general gaze direction or forward direction 604 of the viewer 600 is shown. The horizontal field of view of the picture light received by the vehicle windscreen 602 from the picture generating unit, which is expanded and relayed by the pupil expander (not shown) to the eye box, is represented by arrow 606. Notably, the vehicle windscreen 602 is tilted relative to the forwards direction 604 of the viewer 600, and it is curved. That is, the vehicle windscreen 602 is not straight across in front of the viewer 600. The vehicle windscreen 602 is not planar.

FIG. 6B shows the intensity of horizontally polarised light at the eye-box (i.e. after reflection from the combiner) and FIG. 6C shows the intensity of vertically polarised light at the eye-box. The vertical scale of FIG. 6B is not the same as the vertical scale of FIG. 6C. In fact, the intensity of the horizontal polarisation is approximately ten times that of the vertical polarization. The horizontal polarization is sometimes said to be dominant. The inventors have found that the general trend shown in FIGS. 6B and 6C is not dependent on the direction of linear polarisation of the light emitted by the picture generating unit. FIGS. 6B and 6C relate to one representative direction of linear polarization from the picture generating unit by way of example.

FIGS. 6B and 6C are obtained by taking an initial direction of linear polarisation of light emitted from the picture generating unit of the HUD and tracing it to the eye-box. At the windshield, the light is resolved into s-polarization and p-polarization components and the reflected intensities of the s-polarization and p-polarization components calculated. After reflection, the reflected s-polarization and p-polarization components result in a new orientation of linear polarisation. The reflected light propagates to the eye-box where it is resolved into vertical and horizontal polarisation.

In this case, owing to the tilt of the windshield, light which reaches the eye-box with vertical polarisation may have been s-polarised when incident on the windshield (i.e. some of the light reflected as s-polarization can resolve to the vertical direction). The intensity at the eye-box is not solely linked to one of the s-polarization and p-polarization reflectivities of the glass of the windshield.

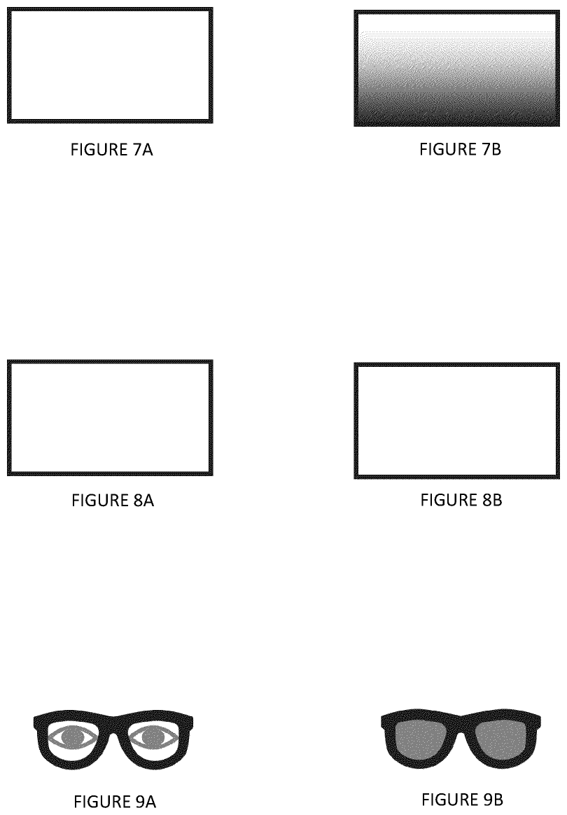

FIG. 7A shows an example luminance profile for a user without polarized lenses or glasses, the profile being substantially uniform (i.e. the grey level of every pixel is the same). FIG. 7B shows the luminance profile that would be perceived by a user wearing polarized lenses or glasses, such that the profile varies, undesirably, with intensity.

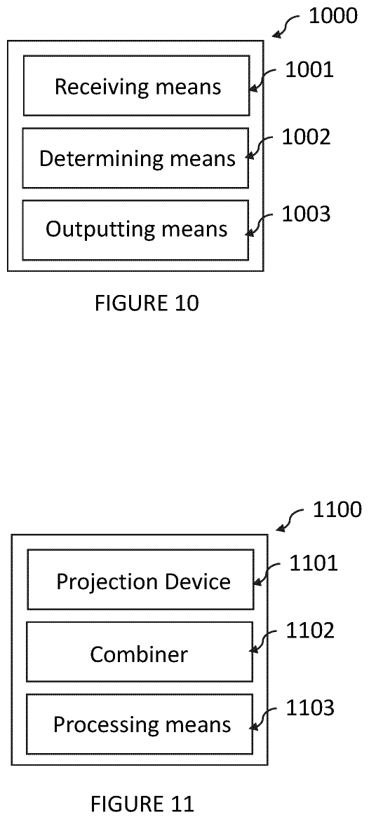

The inventors have recognised that this problem may be addressed by the use of a processing means 1000. The processing means 1000 is described with reference to FIG. 10. The processing means comprises a receiving means 1001, a determining means 1002 and an outputting means 1003.

The receiving means 1001 receives a signal indicative of the presence of a polarizing filter or element in an eye box of the display system. The determining means 1002 determines a corrective data set to apply to the picture to be displayed to the user, based on the signal. The outputting means 1003 outputs the corrective data set to a display device of the display system, in order to display the picture.

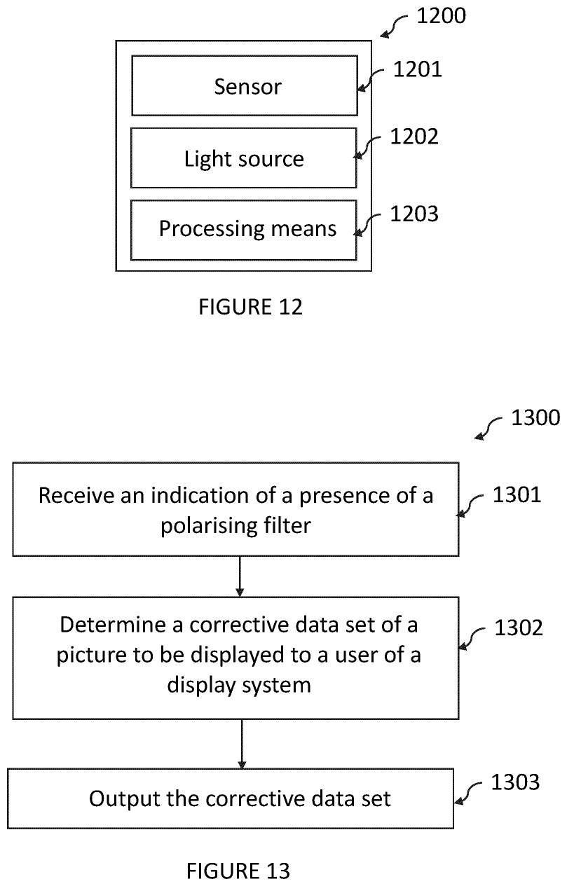

The signal indicative of the presence of the polarizing filter may be input by a user, such that a user indicates to the system that they are wearing polarized glasses. Alternatively, the signal may be generated and received from an eye tracking system, which is described with reference to FIG. 12.

The eye tracking system 1200 comprises a sensor 1201, a light source and a processing means 1203. The sensor is configured to image the eye of a user, and track the direction of gaze of the eye and/or the eye position within the eye-box. The sensor 1201 is illuminated using a light source 1202. The light source 1202 is a non-visible light source such that it does not distract the user. The light source 1202 may comprise an infra-red (IR) source.

The light source 1202 may be operated in a first mode, where horizontally polarized light is used, such that the light is blocked by vertically polarized filters and the eyes of the user are no longer visible. In this way, the eye tracking system 1200 is able to detect the presence of a polarizing filters (e.g. sunglasses) in the eye box. This is indicated in FIG. 9B, where the eyes are not visible.

The eye tracking system 1200 may also comprise a second mode, where the light from the light source 1202 is either vertically polarized, or non-polarized such that it is able to detect the eyes of the user even if the user is wearing (sun)glasses. This is indicated in FIG. 9A, where the eyes are visible. The eye-tracking system 1200 may be used predominately in the second mode allows the eye tracking system 1200 to track the eyes for as long a time as possible. The duration of the first mode would reflect the expected frequency of the user adding or removing polarizing filters, and therefore would be relatively short compared to the second mode.

Although FIGS. 10 and 12 are described with relation to the detection of vertically polarized filters, it is apparent that the techniques described would work similarly for the detection of other types of polarized filters. The eye tracking system 1200 could comprise multiple states, where each state was intended to detect a certain type of polarized filter by using the corresponding cross-polarized state. Alternatively, the eye tracking system 1200 could be arranged to detect a single polarization filter, for example the presence of a horizontally polarized filter.

If the processing means 1000 receives an indication that there is a polarizing filter is present, then a correction to the picture may be made using a corrective data set. The corrective data set may correct for a variation in combiner reflectivity (e.g. as a function of angle) such that the picture perceived by the user is more faithful to the intended picture. This is indicated in FIGS. 8A and 8B. In FIG. 8A shows an intended luminance profile for a user when viewed without polarizing filters. FIG. 8B shows the luminance profile perceived by a user wearing polarizing filter after the correction by the corrective data set has been applied. As can be seen in comparison with FIG. 7B, the picture is now at the desired uniformity (in this example, uniform intensity). For the avoidance of doubt, the pictures (FIGS. 7A and 8A) are uniform by way of example only to illustrate the (negative) effect of polarising sunglasses (FIG. 7B) and the (positive) effect of the corrective data set (FIG. 8B)—which is implemented when the polarising element is detected in the eye-box (e.g. sunglasses on the viewer). In an embodiment, a first corrective data set is used in a first operating state (e.g. detection of a polariser) and a second corrective data set is used in a second operating state (e.g. no detection of a polariser). In another embodiment, one of the operating states does not use a corrective data set—that is, only one of the operating states using a corrective data set.

The colour balance in the picture may also be adjusted to compensate for any difference in colour balance for the image propagated through the pupil expander with polarization suitable for viewing through polarized sunglasses. The person skilled in the art understands that reflectivity of light propagated through the pupil expander may also be dependent on wavelength and they will further understand from the prior description that the method disclosed herein may be extended to change the colour balance (that is, the ratio of the relative intensities of the red, green and blue image components) of the picture before further processing and/or hologram calculation in order to correct for any distortion of the colour balance caused by the different angles of incidence on the combiner.

In particular, in a holographic display system as described herein, a multicolour or polychromatic picture is presented to the user by means of three single wavelength holograms representing respective colour components (e.g. R, G, B) of the picture. The R, G, B holograms are reconstructed at the eye box at the same time (or within the integration time of the human eye) so that a polychromatic reconstruction is perceived. The colour balance of the picture corresponds to the ratio of the colour components R:G:B (i.e. the relative intensities of the pixels of the R, G, B colour components of the image). Typically, the reflectivity of the partially transmissive/reflective surface of the waveguide pupil expander is highly wavelength dependent. This leads to a change in the colour balance of the pixels of the picture when viewed from different positions within the (expanded) eye box, because different positions within the eye box receive light that has undergone different number of “bounces” at the partially transmissive/reflective surface of the waveguide. Accordingly, the colour balance/imbalance of the pixels might appear to change as the viewer moves position within the eye box. Furthermore, in embodiments in which the hologram is said to be “channeling” (in the hologram domain) as described herein, different parts of the picture experience a different number of “bounces” in the waveguide pupil expander. Thus, the left-hand side of the picture might experience more of a certain colour imbalance/shift (e.g. R:B) than the right-hand side. This problem may be addressed by applying a corrective data set to one or more of the R, G, B colour components of the target image to compensate for the colour imbalance. As the skilled person will appreciate, the amount of compensation for colour imbalance is a function of eye position within the eye-box and so the corrective data set used for hologram calculation is dependent upon eye box position. By correcting for colour balance, the picture advantageously appears consistent to the user at all positions within the eye box.

Accordingly, a corrective data set may be determined for each eye box position of a display system, that corrects for changes in quality of the target image introduced by one or more components of a projection system between the picture generating unit and the eye box. A first corrective data set may be determined for when a polarising filter or element is present at the eye box and a second corrective data set may be determined for when a polarising filter or element is not present. Each corrective data set may correspond to the pixels of the picture and may be applied to the pixels of the image (e.g. as scaling factor) prior to calculation of a hologram of the image. The corrective data set may correct for variations in luminance profile of the picture due to variations in reflectivity of an optical combiner (e.g. as a function of angle). In addition, or alternatively, the corrective data set may correct for variations in colour balance of the picture due to variations in reflectivity and/or transmissivity of one or more surfaces of a pupil expander. As the skilled person will appreciate, corrective data sets as described herein may be used for any target picture to be displayed to the user by the display system. Accordingly, in some embodiments, a data storage (e.g. memory) may store a matrix (e.g. look-up table) comprising a plurality of first and second corrective data sets for a respective plurality of eye box positions. In this case, the processing means 1000 may be arranged to select and output the appropriate corrective data set according to (i) a received signal indicating the presence or absence of a polarising filter at the eye box and (ii) a received signal indicating a detected eye box position of the user.

FIG. 11 illustrates an augmented reality display system 1100 in accordance with some embodiments. The augmented reality display system 1100 comprises a projection (e.g. display or relay) device 1101, a combiner 1102 and a processing means 1103.

The projection device 1101 may be any appropriate system to receive visible light from a light source and modulate or otherwise modify the light such that it carries a picture. In some embodiments the projection device 1101 may be configured for use with non-holographic systems, such that there is a direct mapping between pixels displayed on the projection device 1101 and the picture viewed by the user. In other embodiments, the projection device 1101 may be configured for use with holographic systems, such that a hologram is displayed on the projection device 1101, and is illuminated, so as to output light that may be transformed (e.g. Fourier or Fresnel transform) in order to see the picture (i.e. a holographic reconstruction or replay image of the picture).

The combiner 1102 combines the picture bearing light from the projection device 1101 and combines it with visible light from an outside scene to present an augmented reality display to the user. The combiner 1102 may have different responses to s-polarized and p-polarized light.

The processing means 1103 may calculate an appropriate correction if a polarized filter is detected, for example the correction may be a change in the luminosity profile of the image, or a change in the RGB balance. The correction may be applied by outputting it to the projection device 1102. In the case of a non-holographic display a correction per pixel of the display may be calculated and applied to the display. However, in the case of a holographic display as described herein, the correction may be applied as a part of the hologram calculation or prior to hologram calculation (e.g. to change the luminance profile and/or RGB balance of the target image before input to a hologram calculation engine for hologram calculation).

FIG. 13 illustrates a method 1300 according to some embodiments. The method comprises: receiving an indication of a presence of a polarizing filter 1301; determining, based on the indication of the presence of the polarizing filter, a corrective data set of a picture to be displayed to a user of a display system 1302; and outputting the corrective data set to the display system to display the picture in the eye box using the corrective data set 1303. In embodiments described herein, the display system is a holographic display system that calculates one or more holograms of one or more colour components of a target image representing the picture. The display system applies the corrective data set to the target image (or each colour component thereof) prior to, or during, hologram calculation. A picture generating unit (or display device) displays a diffractive pattern comprising the (or each) hologram and is illuminated to output picture light comprising a diffracted light field. In some embodiments, the diffracted light field comprises diverging ray bundles. In some embodiments, the image formed by the diffracted light field is a virtual image. For example, the virtual image may be formed by an optical combiner. In embodiment, the diffracted light field is propagated through a pupil expander to expand the eye box of the display system.

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In aspects, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A processing means, for use in a display system to display a picture in an eye box to a user, the processing means configured to:
receive a signal indicative of a presence a polarizing element in the eye box;
determine a corrective data set for the picture based on the signal, each data value of the corrective data set corresponding to a pixel of the picture; and
output the corrective data set to the display system such that the picture is displayed based on the presence of the polarizing element.

2. The processing means according to claim 1, wherein the corrective data set is a first set of values if the signal indicates the presence of the polarizing element, and a second set of values in the absence of an indication of the polarizing element in the eye box, the second set of values and first set of values being different.

3. The processing means according to claim 1 or 2, wherein when the signal indicates the presence of the polarizing filter, the corrective data set modifies an intensity profile of the picture, such that the picture is observed by the user has an intended intensity profile after filtering by the polarizing element.

4. The processing means according to any preceding claim, wherein the corrective data set is arranged to change at least one of a luminance profile of the picture and a colour balance of the picture.

5. A processing means as claim in any preceding claim wherein the signal is provided by a user-tracking system operating in a secondary mode of operation, wherein the primary mode of operation comprises user-tracking and the secondary mode of operating comprises detecting for the presence of the polarizing element.

6. A processing means as claimed in any preceding claim wherein the polarizing element in the eye-box is a pair of polarising glasses worn by the user.

7. A processing means as claimed in any preceding claim wherein determining the corrective data set comprises selecting the corrective data set from a plurality of different corrective data sets, optionally, wherein there are only two different corrective data sets.

8. A processing means as claimed in any preceding claim wherein the signal is indicative of the polarisation state of the light received by the user.

9. A processing means as claimed in any preceding claim further configured to:
determine a hologram of the picture for display,
wherein the processing means is arranged to apply the output corrective data set to an image data set representative of the picture prior to or during calculation of the hologram of the picture.

10. A display system comprising:
a display device configurable to receive visible light from a visible light source and modify the light such that picture-bearing light is relayed to the user from the display device;
a combiner configurable to receive the picture-bearing light from the display device and combine with an external scene to present an augmented reality scene to a user;
an optional pupil expander, between the combiner and the user, configurable to receive light from the combiner and to expand an eye box of the display system within which the augmented reality scene is visible to the user; and
a processing means according to any of claims 1 to 9.

11. A display system as claimed in claim 10 wherein the display device and combiner are configured such that the intensity profile of the picture-bearing light is non-uniformly attenuated by reflection off the combiner towards the user.

12. A display system as claimed in claim 10 or 11 wherein the non-uniform attenuation caused by reflection off the combiner is a function of polarisation.

13. A display system as claimed in any of claims 10 to 12 wherein the corrective data set is determined based on the dominant polarisation state of the light reaching the user from the display device, optionally, wherein the polarisation state is a direction of linear polarisation such as horizontal polarisation or vertical polarisation.

14. A display system as claimed in any of claims 10 to 13 further comprising:
a user tracking system arranged to determine an eye-box position of a user,
wherein the processing means is arranged to determine the corrective data set for the picture additionally based on the eye-box position of the user.

15. A display system as claimed in any of claims 10 to 14 wherein the processing means is arranged to determine the corrective data by selecting one of a plurality of corrective data sets stored in memory based on a signal indicating the presence or absence of the polarizing element and/or a signal indicating an eye box position of a user.

16. A user-tracking system comprising:
a light system arranged to illuminate an eye-box of a head-up display system with non-visible light, wherein the light system further comprises a polarization selector arranged to determine a polarization state of the non-visible light illuminating the eye-box;
a detection system arranged to form images of the eye-box using the non-visible light; and
a controller arranged to operate the light system and detection system in a primary operating mode for detecting an eye-box position of a user and a secondary operating mode for detecting the presence or absence of a polarising element, such as polarising glasses, associated with the eye-box or user.

17. A user-tracking system as claimed in claim 16 wherein the non-visible light is linearly polarized.

18. A user-tracking system as claimed in claim 16 or 17 wherein, in the secondary operating mode, the polarization state of the non-visible light is vertically polarized.

19. A user-tracking system as claimed in any of claim 16 or 18 wherein, in the primary operating mode, the polarization state of the non-visible light has a horizontal component.

20. A user-tracking system as claimed in any of claim 16 or 19 wherein, in the primary operating mode, the polarization state of the non-visible light is horizontally polarized or non-polarized.

21. A user-tracking system as claimed in any of claims 16 to 20 wherein the light system comprises a first illuminator arranged output non-visible light having the first polarization state and a second illuminator arranged to output non-visible light having the second polarization state, wherein the polarization selector is arranged to have the first illuminator illuminate the eye-box in the first operating mode and have the second illuminator illuminate the eye-box in the second operating mode.

22. A user-tracking system as claimed in any of claims 16 to 21 wherein the polarization selector is arranged to change the polarization state of the non-visible light when the operating mode is changed.

23. A user-tracking system as claimed in any of claims 16 to 22 wherein the primary operating mode is used more frequently than the secondary operating mode during normal operation.

24. A user-tracking system as claimed in any of claims 16 to 23 wherein, in the secondary operating mode, the controller is arranged to output a first control signal for a display system if the presence of a polarizing element is detected and output a second control signal for the display system if the presence of a polarizing element is not detected.
